(19) United States
(12) Patent Application Publication
(10) Pub. No.: US 2025/0246362 A1
(43) Pub. Date: Jul. 31, 2025

(54) COIL COMPONENT

(71) Applicant: Murata Manufacturing Co., Ltd., Kyoto-fu (JP)

(72) Inventors: Hayato TAKAHASHI, Nagaokakyo-shi (JP); Yuki KANBE, Nagaokakyo-shi (JP); Ryutaro KUBO, Nagaokakyo-shi (JP); Akio IGARASHI, Nagaokakyo-shi (JP); Shingo NAKAMOTO, Nagaokakyo-shi (JP)

(73) Assignee: Murata Manufacturing Co., Ltd., Kyoto-fu (JP)

(21) Appl. No.: 19/035,344

(22) Filed: Jan. 23, 2025

(30) Foreign Application Priority Data
Jan. 26, 2024 (JP) 2024-010410

(51) Int. Cl. H01F 27/29; H01F 27/28

(52) U.S. Cl. CPC H01F 27/292; H01F 27/2823

(57) ABSTRACT

A coil component includes a drum core, a first metal terminal, and a first wire. The drum core includes a columnar winding core, a first flange at a first end in a direction along a central axis of the winding core, and a second flange at a second end opposite to the first end of the winding core. The first metal terminal is on the first flange. The first metal terminal has a first joining part facing an upper surface of the first flange. The first joining part has a first inclined portion having an upper surface inclined in the downward direction toward the winding core in a direction along a left-right axis. A first end of the first wire is joined to an upper surface of the first joining part. In addition, the first wire overlaps the first inclined portion when viewed downward.

### CROSS-REFERENCE TO RELATED APPLICATION

This application claims benefit of priority to Japanese Patent Application No. 2024-010410, filed Jan. 26, 2024, the entire content of which is incorporated herein by reference.

### BACKGROUND

### Technical Field

The present disclosure relates to a coil component.

### Background Art

A coil component described in Japanese Patent Application Laid-Open No. 2019-050317 includes a winding core and two flanges. The winding core has a quadrangular prism shape. The two flanges are connected to both ends of the winding core. Each flange protrudes outward from the winding core in a direction orthogonal to a central axis of the winding core. The winding core and the flanges constitute a core of the coil component. Further, the coil component described in Japanese Patent Application Laid-Open No. 2019-050317 includes an electrode and a wire. The electrode is attached to the flange. The wire is wound around the winding core. An end of the wire is attached to the electrode by thermocompression bonding.

### SUMMARY

In the coil component described in Japanese Patent Application Laid-Open No. 2019-050317, the wire thermocompression-bonded at the electrode is crushed on the electrode. Therefore, the wire on the electrode may be deformed into a flat shape without maintaining an outer diameter before thermocompression bonding. When such a flat portion of the wire extends to an edge of the electrode, the wire may be disconnected at the edge.

Accordingly, the present disclosure provides a coil component including a drum core including a columnar winding core, a first flange connected to a first end in a direction along a central axis of the winding core, and a second flange connected to a second end opposite to the first end of the winding core; a first metal terminal attached to the first flange; and a first wire wound around the winding core and having a first end and a second end opposite to the first end. The first flange protrudes outward with respect to the winding core in a direction along an up-down axis orthogonal to the central axis. Also, when an axis orthogonal to both the up-down axis and the central axis is defined as a left-right axis, one of directions along the up-down axis is defined as an upward direction, and a direction opposite to the upward direction is defined as a downward direction, the first metal terminal includes a first joining part facing an upper surface of the first flange, the first joining part includes a first inclined portion having an upper surface inclined in the downward direction toward the winding core in a direction along the left-right axis, and a first end of the first wire is joined to an upper surface of the first joining part, and the first wire overlaps the first inclined portion when viewed toward the downward direction.

According to the above configuration, disconnection of a wire near the metal terminal can be suppressed.

### BRIEF DESCRIPTION OF THE DRAWINGS

FIG. 1 is a perspective view of a coil component;

FIG. 2 is a top view of the coil component;

FIG. 3 is an enlarged view when the coil component is viewed in a first negative direction;

FIG. 4 is a top view of the coil component according to a modification; and

FIG. 5 is a perspective view of the coil component according to the modification.

### DETAILED DESCRIPTION

Hereinafter, an embodiment of a coil component will be described with reference to the drawings. Note that in the drawings, components may be shown in an enlarged manner for easy understanding. Dimensional ratios of the components may be different from actual ones or those in another drawing.

### Overall Configuration

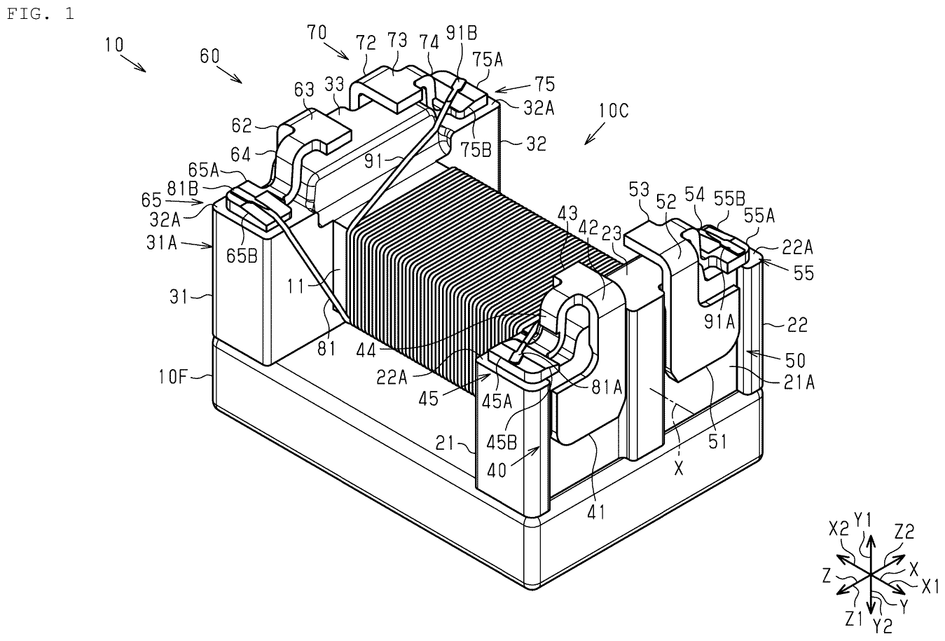

As shown in FIG. 1, a coil component 10 includes a drum core 10C and a plate core 10F.

The drum core 10C includes a winding core 11, a first flange 21, and a second flange 31.

The winding core 11 has a quadrangular prism shape. A material of the winding core 11 is, for example, alumina, Ni-Zn-based ferrite, synthetic resin, or a mixture thereof.

The first flange 21 is provided at a first end of the winding core 11 in a direction along a central axis X. In other words, the first flange 21 is connected to the first end of the winding core 11 in the direction along the central axis X. The second flange 31 is provided at a second end of the winding core 11 in the direction along the central axis X. In other words, the second flange 31 is connected to the second end of the winding core 11 in the direction along the central axis X. A material of the first flange 21 and the second flange 31 is the same as that of the winding core 11. Further, the first flange 21 and the second flange 31 are integrally molded with the winding core 11.

Here, a specific axis orthogonal to the central axis X is defined as an up-down axis Y. In the present embodiment, when viewed toward a direction along the central axis X, the up-down axis Y is a direction orthogonal to a mounting surface when the coil component 10 is mounted on a substrate. Further, an axis orthogonal to both the central axis X and the up-down axis Y is defined as a left-right axis Z. Then, one of directions along the central axis X is defined as a first positive direction X1, and a direction opposite to the first positive direction X1 is defined as a first negative direction X2. In the present embodiment, the first positive direction X1 coincides with a direction from the winding core 11 toward the first flange 21. The first negative direction X2 coincides with a direction from the winding core 11 toward the second flange 31. Further, one of directions along the up-down axis Y is defined as an upward direction Y1, and a direction opposite to the upward direction Y1 is defined as a downward direction Y2. Further, one of directions along the left-right axis Z is defined as a rightward direction Z1, and a direction opposite to the rightward direction Z1 is defined as a leftward direction Z2. Note that the upward direction Y1 and the downward direction Y2 here are referred to for convenience and do not specify a gravity direction. Furthermore, the rightward direction Z1 and the leftward direction Z2 are also referred to for convenience, and are not intended to limit a left and right direction from a specific viewpoint.

In the present disclosure, an “upper surface” refers to a surface facing the upward direction Y1 in a direction along the up-down axis Y, and a “lower surface” refers to a surface facing the downward direction Y2. Note that the “upper surface” is not necessarily strictly orthogonal to the upward direction Y1, and for example, when the coil component 10 is viewed from the upward direction Y1 to the downward direction Y2 with respect to the coil component 10, a visible surface is referred to as an “upper surface of the coil component 10”. The same applies to the lower surface.

The first flange 21 protrudes outward with respect to the winding core 11 in directions along the up-down axis Y and the left-right axis Z when viewed from the direction along the central axis X. The first flange 21 has a symmetrical shape in a direction along the left-right axis Z. The first flange 21 has an outer end surface 21A. The outer end surface 21A is a surface facing the first positive direction X1 of outer surfaces of the first flange 21.

The first flange 21 includes a main body 22 and a projecting portion 23. The main body 22 has a substantially rectangular parallelepiped shape with a small thickness in the direction along the central axis X. When viewed toward the first negative direction X2, both edges of the main body 22 in the upward direction Y1 and the downward direction Y2 are parallel to the left-right axis Z. Further, when viewed toward the first negative direction X2, both edges of the main body 22 in the leftward direction Z2 and the rightward direction Z1 are parallel to the up-down axis Y.

The projecting portion 23 projects from an upper surface 22A of the main body 22 toward the upward direction Y1. The projecting portion 23 has a quadrangular truncated pyramid shape in which a dimension in the direction along the left-right axis Z decreases toward the upward direction Y1. The projecting portion 23 is located substantially at a center of the main body 22 in the direction along the left-right axis Z. A dimension of the projecting portion 23 in the direction along the central axis X is the same as a dimension of the main body 22 in the direction along the central axis X. Note that the main body 22 and the projecting portion 23 are integrally molded. That is, there is no clear boundary between the main body 22 and the projecting portion 23 inside the first flange 21.

The second flange 31 has a symmetrical shape to the first flange 21 with respect to the direction along the left-right axis Z. That is, the second flange 31 protrudes outward with respect to the winding core 11 in the direction along the up-down axis Y and the direction along the left-right axis Z when viewed from the direction along the central axis X. Then, the second flange 31 has an outer end surface 31A facing the first negative direction X2. The second flange 31 includes a main body 32 and a projecting portion 33. Configurations of the main body 32 and the projecting portion 33 of the second flange 31 are similar to those of the main body 22 and the projecting portion 23 of the first flange 21. That is, the projecting portion 33 projects from an upper surface 32A of the main body 32 toward the upward direction Y1.

The plate core 10F has a rectangular plate shape. A long side of the plate core 10F is parallel to the central axis X. A short side of the plate core 10F is parallel to the left-right axis Z. The plate core 10F is located on the downward direction Y2 side with respect to the drum core 10C. The plate core 10F is connected to both a lower surface of the first flange 21 and a lower surface of the second flange 31. That is, the plate core 10F is bridged between the first flange 21 and the second flange 31. A material of the plate core 10F is the same as a material of the drum core 10C.

The coil component 10 includes a first metal terminal 40, a second metal terminal 50, a third metal terminal 60, and a fourth metal terminal 70.

The first metal terminal 40 is provided on the first flange 21. That is, the first metal terminal 40 is attached to the first flange 21. The first metal terminal 40 is located on the rightward direction Z1 side with respect to the central axis X in the first flange 21. The second metal terminal 50 is provided on the first flange 21. That is, the second metal terminal 50 is attached to the first flange 21. The second metal terminal 50 is located on the leftward direction Z2 side with respect to the central axis X in the first flange 21. That is, the second metal terminal 50 is attached to a portion of the first flange 21 opposite to the first metal terminal 40 across the central axis X in the direction along the left-right axis Z. The third metal terminal 60 is provided on the second flange 31. That is, the third metal terminal 60 is attached to the second flange 31. The third metal terminal 60 is located on the rightward direction Z1 side with respect to the central axis X in the second flange 31. That is, the third metal terminal 60 faces the first metal terminal 40 in the direction along the central axis X. The fourth metal terminal 70 is provided on the second flange 31. That is, the fourth metal terminal 70 is attached to the second flange 31. The fourth metal terminal 70 is located on the leftward direction Z2 side with respect to the central axis X in the second flange 31. That is, the fourth metal terminal 70 faces the second metal terminal 50 in the direction along the central axis X. Details of the first metal terminal 40 to the fourth metal terminal 70 will be described later.

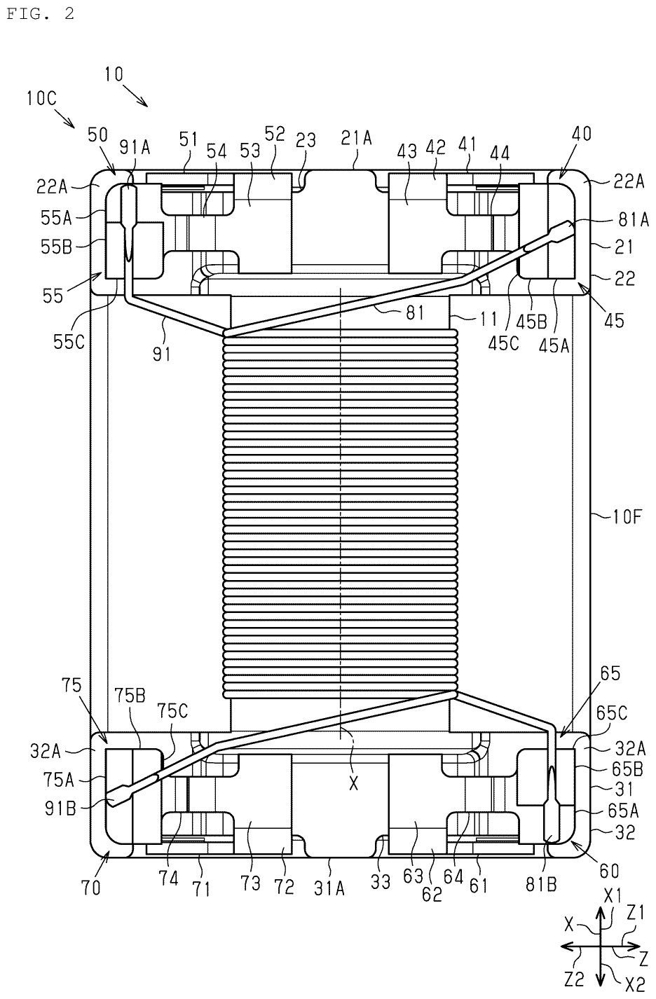

As shown in FIG. 2, the coil component 10 includes a first wire 81 and a second wire 91. Although not shown, the first wire 81 includes a copper wire and an insulating film. The insulating film covers an outer surface of the copper wire. The first wire 81 has a substantially circular shape in a section orthogonal to a direction in which the first wire 81 extends. The first wire 81 has a first end 81A and a second end 81B opposite to the first end 81A.

As shown in FIGS. 1 and 2, the first end 81A of the first wire 81 is joined to the first metal terminal 40 by thermocompression bonding. The first wire 81 extends from the first metal terminal 40 toward a ridgeline of the winding core 11 on the leftward direction Z2 side and the upward direction Y1 side. Then, when viewed toward the first negative direction X2, the first wire 81 is wound around the winding core 11 so as to travel clockwise as it goes in the first negative direction X2. The second end 81B of the first wire 81 extends toward the third metal terminal 60 from a ridgeline of the winding core 11 on the rightward direction Z1 side and the downward direction Y2 side. The second end 81B of the first wire 81 is joined to the third metal terminal 60 by thermocompression bonding.

Note that the thermocompression bonding is a method of sandwiching the wire between the metal terminal and a heated jig, and fixing the wire to the metal terminal while melting the wire. As a result of this fixing method, the insulating film is peeled off near a joining portion with the metal terminal in the wire, and the copper wire is exposed.

The second wire 91 has the same configuration as the first wire 81. That is, the second wire 91 includes the copper wire and the insulating film. The second wire 91 has a first end 91A and a second end 91B opposite to the first end 91A.

The first end 91A of the second wire 91 is joined to the second metal terminal 50 by thermocompression bonding. The second wire 91 extends from the second metal terminal 50 toward a ridgeline of the winding core 11 on the leftward direction Z2 side and the downward direction Y2 side. Then, when viewed toward the first negative direction X2, the second wire 91 is wound around the winding core 11 so as to travel clockwise as it goes in the first negative direction X2. The second end 91B of the second wire 91 extends toward the fourth metal terminal 70 from a ridgeline of the winding core 11 on the rightward direction Z1 side and the upward direction Y1 side. The second end 91B of the second wire 91 is joined to the fourth metal terminal 70 by thermocompression bonding.

### First Metal Terminal

As shown in FIG. 1, the first metal terminal 40 includes a first bonding portion 41, a first coupling portion 42, a first mounting part 43, a first extending portion 44, and a first joining part 45. Note that the first bonding portion 41, the first coupling portion 42, the first mounting part 43, the first extending portion 44, and the first joining part 45 are integrally molded. That is, there is no clear boundary between these members inside the first metal terminal 40.

As shown in FIG. 1, the first bonding portion 41 has a substantially plate shape. The first bonding portion 41 is attached to the outer end surface 21A of the first flange 21 via an adhesive. The first bonding portion 41 is a portion of the first metal terminal 40 facing the outer end surface 21A of the first flange 21 in the direction along the central axis X.

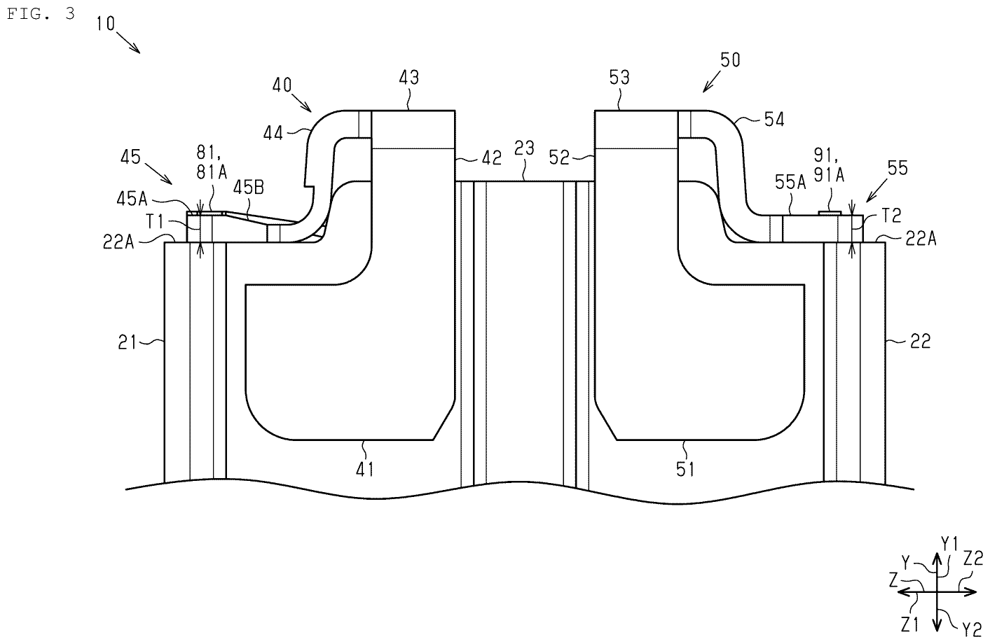

The first coupling portion 42 is connected to an end of the first bonding portion 41 in the upward direction Y1. The first coupling portion 42 extends from the first bonding portion 41 toward the upward direction Y1. That is, as shown in FIG. 3, the first coupling portion 42 protrudes from the first flange 21 toward the upward direction Y1 when viewed toward the first negative direction X2. Specifically, the first coupling portion 42 protrudes toward the upward direction Y1 with respect to the projecting portion 23 of the first flange 21. As shown in FIG. 1, the first coupling portion 42 is bent by about 90 degrees toward the first negative direction X2 on the way. That is, an end of the first coupling portion 42 on a side opposite to the first bonding portion 41 faces the first negative direction X2.

The first mounting part 43 is connected to an end of the first coupling portion 42 opposite to the first bonding portion 41. The first mounting part 43 has a flat plate shape. A main surface of the first mounting part 43 is orthogonal to the up-down axis Y. Further, the first mounting part 43 is a portion of the first metal terminal 40 located on an uppermost side in the upward direction Y1. The first mounting part 43 is separated from the projecting portion 23 of the first flange 21 toward the upward direction Y1. That is, there is a gap between the first mounting part 43 and the first flange 21. Note that the first mounting part 43 is a portion facing the substrate when the coil component 10 is mounted on the substrate.

As shown in FIG. 3, a first end of the first extending portion 44 is connected to an end of the first mounting part 43 in the rightward direction Z1. The first extending portion 44 extends substantially obliquely from the first mounting part 43 toward the rightward direction Z1 and the downward direction Y2. A second end of the first extending portion 44 faces the rightward direction Z1. A thickness dimension of the first extending portion 44 is reduced in the middle of the first extending portion 44 extending from the first end to the second end. That is, the thickness dimension at the second end of the first extending portion 44 is smaller than the thickness dimension at the first end of the first extending portion 44. Note that the thickness dimension of the first extending portion 44 is a dimension in a direction orthogonal to an extending direction of the first extending portion 44.

As shown in FIG. 1, the first joining part 45 is connected to the second end of the first extending portion 44. The first joining part 45 has a substantially plate shape. The first joining part 45 has a substantially rectangular shape elongated in the direction along the central axis X when viewed toward the downward direction Y2.

As shown in FIG. 3, the first joining part 45 faces the upper surface 22A of the main body 22 of the first flange 21 along the up-down axis Y. That is, a lower surface of the first joining part 45 faces an upper surface of the first flange 21. The lower surface of the first joining part 45 is in contact with the upper surface of the first flange 21. On the other hand, the lower surface of the first joining part 45 is not fixed to the first flange 21. That is, no adhesive or the like is interposed between the first joining part 45 and the first flange 21.

As shown in FIG. 2, the first joining part 45 includes a first flat surface part 45A and a first inclined portion 45B. The first flat surface part 45A occupies about half of the first joining part 45 on the rightward direction Z1 side. When viewed toward the downward direction Y2, the first flat surface part 45A has a substantially rectangular shape elongated in the direction along the central axis X. An upper surface of the first flat surface part 45A is orthogonal to the up-down axis Y. Further, a lower surface of the first flat surface part 45A is also orthogonal to the up-down axis Y. Therefore, the first flat surface part 45A has a substantially constant thickness.

The first inclined portion 45B is adjacent to the first flat surface part 45A on the winding core 11 side in the direction along the left-right axis Z. The first inclined portion 45B reaches a first inclined end 45C which is an end of the first joining part 45 on the winding core 11 side in the direction along the left-right axis Z. An upper surface of the first inclined portion 45B is inclined in the downward direction Y2 toward the winding core 11 in the direction along the left-right axis Z. That is, an upper surface of the first joining part 45 is located on a lowermost side in the downward direction Y2 at the first inclined end 45C.

The upper surface of the first inclined portion 45B is planar. That is, the first inclined portion 45B is inclined at a constant inclination in the direction along the left-right axis Z. Further, on the upper surface of the first inclined portion 45B, a dimension in the direction along the up-down axis Y from a position located on the uppermost side in the upward direction Y1 to a position located on the lowermost side in the downward direction Y2 is larger than an outer diameter of the first wire 81. A lower surface of the first inclined portion 45B is orthogonal to the up-down axis Y. The lower surface of the first inclined portion 45B is flush with the lower surface of the first flat surface part 45A.

### Second Metal Terminal

As shown in FIG. 1, the second metal terminal 50 includes a second bonding portion 51, a second coupling portion 52, a second mounting part 53, a second extending portion 54, and a second joining part 55. Note that the second bonding portion 51, the second coupling portion 52, and the second mounting part 53 respectively have shapes obtained by inverting the first bonding portion 41, the first coupling portion 42, and the first mounting part 43 with respect to the direction along the central axis X.

The second bonding portion 51 has a substantially plate shape. The second bonding portion 51 is attached to the outer end surface 21A of the first flange 21 via the adhesive. The second bonding portion 51 is a portion of the second metal terminal 50 facing the outer end surface 21A of the first flange 21 in the direction along the central axis X.

The second coupling portion 52 is connected to an end of the second bonding portion 51 in the upward direction Y1. The second coupling portion 52 extends from the second bonding portion 51 toward the upward direction Y1. That is, as shown in FIG. 3, the second coupling portion 52 protrudes from the first flange 21 toward the upward direction Y1 when viewed toward the first negative direction X2. Specifically, the second coupling portion 52 protrudes toward the upward direction Y1 with respect to the projecting portion 23 of the first flange 21. As shown in FIG. 1, the second coupling portion 52 is bent by about 90 degrees toward the first negative direction X2 on the way. That is, an end of the second coupling portion 52 on a side opposite to the second bonding portion 51 faces the first negative direction X2.

The second mounting part 53 is connected to an end of the second coupling portion 52 opposite to the second bonding portion 51. The second mounting part 53 has a flat plate shape. A main surface of the second mounting part 53 is orthogonal to the up-down axis Y. Further, the second mounting part 53 is a portion of the second metal terminal 50 located on the uppermost side in the upward direction Y1. The second mounting part 53 is separated from the projecting portion 23 of the first flange 21 toward the upward direction Y1. That is, there is a gap between the second mounting part 53 and the first flange 21.

A first end of the second extending portion 54 is connected to an end of the second mounting part 53 in the leftward direction Z2. The second extending portion 54 extends substantially obliquely from the second mounting part 53 toward the leftward direction Z2 and the downward direction Y2. A second end of the second extending portion 54 faces the leftward direction Z2. As shown in FIG. 3, a thickness dimension of the second extending portion 54 is constant from the first end to the second end of the second extending portion 54.

The second joining part 55 faces the upper surface 22A of the main body 22 of the first flange 21 along the up-down axis Y. That is, a lower surface of the second joining part 55 faces the upper surface of the first flange 21. The lower surface of the second joining part 55 is in contact with the upper surface of the first flange 21. On the other hand, the lower surface of the second joining part 55 is not fixed to the first flange 21. That is, no adhesive or the like is interposed between the second joining part 55 and the first flange 21.

As shown in FIG. 2, the second joining part 55 includes a second flat surface part 55A and a second inclined portion 55B. The second flat surface part 55A occupies about half of the second joining part 55 on the first positive direction X1 side. When viewed toward the downward direction Y2, the second flat surface part 55A has a substantially rectangular shape elongated in the direction along the left-right axis Z. An upper surface of the second flat surface part 55A is orthogonal to the up-down axis Y. Further, a lower surface of the second flat surface part 55A is also orthogonal to the up-down axis Y. Therefore, the second surface part 55A has a substantially constant thickness.

The second inclined portion 55B is adjacent to the second flat surface part 55A on the second flange 31 side in the direction along the central axis X. The second inclined portion 55B reaches a second inclined end 55C which is an end of the second joining part 55 on the second flange 31 side in the direction along the central axis X. An upper surface of the second inclined portion 55B is inclined in the downward direction Y2 toward the second flange 31 in the direction along the central axis X. That is, an upper surface of the second joining part 55 is located on the lowermost side in the downward direction Y2 at the second inclined end 55C.

The upper surface of the second inclined portion 55B is planar. That is, the second inclined portion 55B is inclined at a constant inclination in the direction along the central axis X. Further, on the upper surface of the second inclined portion 55B, a dimension in the direction along the up-down axis Y from a position located on the uppermost side in the upward direction Y1 to a position located on the lowermost side in the downward direction Y2 is larger than an outer diameter of the second wire 91. In other words, on the upper surface of the second inclined portion 55B, a dimension in the direction along the up-down axis Y from an end in the first positive direction X1 to an end in the first negative direction X2 is larger than the outer diameter of the second wire 91. A lower surface of the second inclined portion 55B is orthogonal to the up-down axis Y. The lower surface of the second inclined portion 55B is flush with the lower surface of the second flat surface part 55A.

### Third Metal Terminal

As shown in FIG. 2, the third metal terminal 60 has the same shape as the second metal terminal 50. The third metal terminal 60 has a shape obtained by rotating the second metal terminal 50 by 180 degrees about an axis parallel to the up-down axis Y and passing through a center of the winding core 11. The third metal terminal 60 includes a third bonding portion 61, a third coupling portion 62, a third mounting part 63, a third extending portion 64, and a third joining part 65.

The third metal terminal 60 is joined to the outer end surface 31A of the second flange 31 at the third bonding portion 61. As shown in FIG. 1, the third joining part 65 faces the upper surface 32A of the main body 32 of the second flange 31 along the up-down axis Y. That is, a lower surface of the third joining part 65 faces the upper surface of the second flange 31. The lower surface of the third joining part 65 is in contact with the upper surface of the second flange 31. On the other hand, the lower surface of the third joining part 65 is not fixed to the second flange 31. That is, no adhesive or the like is interposed between the third joining part 65 and the second flange 31.

As shown in FIG. 2, the third joining part 65 includes a third flat surface part 65A and a third inclined portion 65B. The third flat surface part 65A occupies about half of the third joining part 65 on the first negative direction X2 side. When viewed toward the downward direction Y2, the third flat surface part 65A has a substantially rectangular shape elongated in the direction along the left-right axis Z. An upper surface of the third flat surface part 65A is orthogonal to the up-down axis Y. Further, a lower surface of the third flat surface part 65A is also orthogonal to the up-down axis Y. Therefore, the third flat surface part 65A has a substantially constant thickness.

The third inclined portion 65B is adjacent to the third flat surface part 65A on the first flange 21 side in the direction along the central axis X. The third inclined portion 65B reaches a third inclined end 65C which is an end of the third joining part 65 on the first flange 21 side in the direction along the central axis X. An upper surface of the third inclined portion 65B is inclined in the downward direction Y2 toward the first flange 21 in the direction along the central axis X. That is, un upper surface of the third joining part 65 is located on the lowermost side in the downward direction Y2 at the third inclined end 65C.

The upper surface of the third inclined portion 65B is planar. That is, the third inclined portion 65B is inclined at a constant inclination in the direction along the central axis X. Further, on the upper surface of the third inclined portion 65B, a dimension in the direction along the up-down axis Y from a position located on the uppermost side in the upward direction Y1 to a position located on the lowermost side in the downward direction Y2 is larger than the outer diameter of the first wire 81. In other words, on the upper surface of the third inclined portion 65B, a dimension in the direction along the up-down axis Y from an end in the first negative direction X2 to an end in the first positive direction X1 is larger than the outer diameter of the first wire 81. A lower surface of the third inclined portion 65B is orthogonal to the up-down axis Y. The lower surface of the third inclined portion 65B is flush with the lower surface of the third flat surface part 65A.

### Fourth Metal Terminal

As shown in FIG. 2, the fourth metal terminal 70 has the same shape as the first metal terminal 40. The fourth metal terminal 70 has a shape obtained by rotating the first metal terminal 40 by 180 degrees about an axis parallel to the up-down axis Y and passing through the center of the winding core 11. The fourth metal terminal 70 includes a fourth bonding portion 71, a fourth coupling portion 72, a fourth mounting part 73, a fourth extending portion 74, and a fourth joining part 75.

The fourth metal terminal 70 is joined to the outer end surface 31A of the second flange 31 at the fourth bonding portion 71. As shown in FIG. 1, the fourth joining part 75 faces the upper surface 32A of the main body 32 of the second flange 31 along the up-down axis Y. That is, a lower surface of the fourth joining part 75 faces the upper surface of the second flange 31. The lower surface of the fourth joining part 75 is in contact with the upper surface of the second flange 31. On the other hand, the lower surface of the fourth joining part 75 is not fixed to the second flange 31. That is, no adhesive or the like is interposed between the fourth joining part 75 and the second flange 31.

As shown in FIG. 2, the fourth joining part 75 includes a fourth flat surface part 75A and a fourth inclined portion 75B. The fourth flat surface part 75A occupies about half of the fourth joining part 75 on the leftward direction Z2 side. When viewed toward the downward direction Y2, the fourth flat surface part 75A has a substantially rectangular shape elongated in the direction along the central axis X. An upper surface of the fourth flat surface part 75A is orthogonal to the up-down axis Y. Further, a lower surface of the fourth flat surface part 75A is also orthogonal to the up-down axis Y. Therefore, the fourth flat surface part 75A has a substantially constant thickness.

The fourth inclined portion 75B is adjacent to the fourth flat surface part 75A on the winding core 11 side in the direction along the left-right axis Z. The fourth inclined portion 75B reaches a fourth inclined end 75C which is an end of the fourth joining part 75 on the winding core 11 side in the direction along the left-right axis Z. An upper surface of the fourth inclined portion 75B is inclined in the downward direction Y2 toward the winding core 11 in the direction along the left-right axis Z. That is, the upper surface of the fourth joining part 75 is located on the lowermost side in the downward direction Y2 at the fourth inclined end 75C.

The upper surface of the fourth inclined portion 75B is planar. That is, the fourth inclined portion 75B is inclined at a constant inclination in the direction along the left-right axis Z. Further, on the upper surface of the fourth inclined portion 75B, a dimension in the direction along the up-down axis Y from a position located on the uppermost side in the upward direction Y1 to a position located on the lowermost side in the downward direction Y2 is larger than the outer diameter of the second wire 91. In other words, on the upper surface of the fourth inclined portion 75B, a dimension in the direction along the up-down axis Y from an end in the leftward direction Z2 to an end in the rightward direction Z1 is larger than the outer diameter of the second wire 91. A lower surface of the fourth inclined portion 75B is orthogonal to the up-down axis Y. The lower surface of the fourth inclined portion 75B is flush with the lower surface of the fourth flat surface part 75A.

### Relationship Between Thickness Dimensions of Metal Terminals

As shown in FIG. 3, a thickness dimension T1 from the lower surface to the upper surface of the first flat surface part 45A in the direction along the up-down axis Y is equal to a thickness dimension T2 from the lower surface to the upper surface of the second flat surface part 55A in the direction along the up-down axis Y. Further, as described above, the lower surface of the first flat surface part 45A is in contact with the upper surface 22A of the main body 22 of the first flange 21. Further, the lower surface of the second flat surface part 55A is in contact with the upper surface 22A of the main body 22 of the first flange 21. Therefore, a shortest distance from the upper surface of the first flange 21 to the first flat surface part 45A in the direction along the up-down axis Y is equal to a shortest distance from the upper surface of the first flange 21 to the second flat surface part 55A in the direction along the up-down axis Y. In the present embodiment, the shortest distance from the upper surface of first flange 21 to the first flat surface part 45A is zero.

Note that thickness dimensions of flat surface parts in the direction along the up-down axis Y are equal. That is, the thickness dimension T1 of the first flat surface part 45A, the thickness dimension T2 of the second flat surface part 55A, a thickness dimension of the third flat surface part 65A, and a thickness dimension of the fourth flat surface part 75A in the direction along the up-down axis Y are equal.

In addition, the shortest distance from the upper surface of the second flange 31 to the third flat surface part 65A in the direction along the up-down axis Y is equal to a shortest distance from the upper surface of the second flange 31 to the fourth flat surface part 75A in the direction along the up-down axis Y. In the present embodiment, the shortest distance from the upper surface of the second flange 31 to the third flat surface part 65A is zero.

As shown in FIG. 2, an area of the upper surface of the first flat surface part 45A, an area of the upper surface of the second flat surface part 55A, an area of the upper surface of the third flat surface part 65A, and an area of the upper surface of the fourth flat surface part 75A are equal to each other. That is, the areas of the upper surfaces of the flat surface parts of the metal terminals are equal to each other.

### Positional Relationship Between Each Metal Terminal and Each Wire

The first end 81A of the first wire 81 is joined to the upper surface of the first flat surface part 45A and the upper surface of the first inclined portion 45B of the first joining part 45. In addition, when viewed toward the downward direction Y2, the first wire 81 overlaps the first inclined portion 45B. When viewed toward the downward direction Y2, the first wire 81 also overlaps the first inclined end 45C which is an end of the first joining part 45 on the winding core 11 side in the direction along the left-right axis Z.

The second end 81B of the first wire 81 is joined to the upper surface of the third flat surface part 65A of the third joining part 65. In addition, when viewed toward the downward direction Y2, the first wire 81 overlaps the third inclined portion 65B. When viewed toward the downward direction Y2, the first wire 81 also overlaps the third inclined end 65C which is an end of the third joining part 65 on the first flange 21 side in the direction along the central axis X.

The first end 81A and the second end 81B of the first wire 81 are deformed into a flat shape by thermocompression bonding. The first wire 81 is less affected by thermocompression bonding on the first inclined end 45C and the third inclined end 65C. Therefore, on the first inclined end 45C and the third inclined end 65C, the outer diameter of the first wire 81 is maintained as compared with that on the first flat surface part 45A and the third flat surface part 65A.

The first end 91A of the second wire 91 is joined to the upper surface of the second flat surface part 55A and the upper surface of the second inclined portion 55B of the second joining part 55. In addition, when viewed toward the downward direction Y2, the second wire 91 overlaps the second inclined portion 55B. When viewed toward the downward direction Y2, the second wire 91 also overlaps the second inclined end 55C which is an end of the second joining part 55 on the second flange 31 side in the direction along the central axis X.

The second end 91B of the second wire 91 is joined to the upper surface of the fourth flat surface part 75A of the fourth joining part 75. In addition, when viewed toward the downward direction Y2, the second wire 91 overlaps the fourth inclined portion 75B. When viewed toward the downward direction Y2, the second wire 91 also overlaps the fourth inclined end 75C which is an end of the fourth joining part 75 on the winding core 11 side in the direction along the left-right axis Z.

The first end 91A and the second end 91B of the second wire 91 are deformed into a flat shape by thermocompression bonding. On the other hand, the second wire 91 is less affected by thermocompression bonding on the second inclined end 55C and the fourth inclined end 75C. Therefore, on the second inclined end 55C and the fourth inclined end 75C, the outer diameter of the second wire 91 is maintained as compared with that on the second flat surface part 55A and the fourth flat surface part 75A.

### Effects of the Present Embodiment

(1) In the above embodiment, the upper surface of the first inclined portion 45B of the first metal terminal 40 is inclined in the downward direction Y2 toward the winding core 11. Therefore, also when the first wire 81 is deformed by being crushed vertically on the first joining part 45 by thermocompression bonding or the like, the shape of the first wire 81 is easily maintained in a state before thermocompression bonding in a portion of the first wire 81 on the winding core 11 side of the first inclined portion 45B. Therefore, it is possible to suppress disconnection of the first wire 81 at a portion on an edge of the first joining part 45 in the first wire 81.

(2) In the above embodiment, the first joining part 45 has the first flat surface part 45A. Further, the first end 81A of the first wire 81 is joined to the first flat surface part 45A. Since the upper surface of the first flat surface part 45A is a flat surface orthogonal to the up-down axis Y, when a pressure bonding tool is pressed along the up-down axis Y, the first wire 81 is pressure bonded to the first flat surface part 45A with substantially equal force. Therefore, it is easy to manage a pressure bonding force against the first flat surface part 45A. In this respect, the same effect is obtained also in the flat surface part of each metal terminal.

(3) In the above embodiment, when viewed toward the downward direction Y2, the first wire 81 overlaps the first inclined end 45C. According to this configuration, the first wire 81 passes over the first inclined end 45C located on the lowermost side in the downward direction Y2 in the first inclined portion 45B. Therefore, also when the first wire 81 is deformed to be crushed along the up-down axis Y on the first joining part 45, the shape of the first wire 81 is easily maintained on the first inclined end 45C. In this respect, the same effect is obtained also in the inclined end of each metal terminal.

(4) In the above embodiment, when viewed toward the downward direction Y2, the second wire 91 overlaps the second inclined portion 55B. According to this configuration, the second inclined portion 55B is located along a direction in which the second wire 91 is extended from a portion where the second wire 91 is wound around the winding core 11 toward the second metal terminal 50. Therefore, the effect described in (1) is also obtained near the first end 81A of the second wire 91.

(5) In the above embodiment, the shortest distance from the upper surface of the first flange 21 to the first flat surface part 45A is equal to the shortest distance from the upper surface of the first flange 21 to the second flat surface part 55A. According to this configuration, when the first wire 81 is thermocompression-bonded to the first flat surface part 45A and the second wire 91 is thermocompression-bonded to the second flat surface part 55A, since positions of joining portions for the wires in the direction along the up-down axis Y are the same, a load at the time of thermocompression bonding is less likely to be biased.

(6) In the above embodiment, the thickness dimension T1 from the lower surface to the upper surface of the first flat surface part 45A is equal to the thickness dimension T2 from the lower surface to the upper surface of the second flat surface part 55A. According to this configuration, also when the lower surface of each flat surface part comes into contact with the first flange 21 at the time of thermocompression bonding with each wire, since the thickness dimensions of the flat surface parts are the same, the load at the time of thermocompression bonding is not biased.

(7) In the above embodiment, when viewed toward the downward direction Y2, the first wire 81 overlaps the third inclined portion 65B. When viewed toward the downward direction Y2, the second wire 91 overlaps the fourth inclined portion 75B. Therefore, the third metal terminal 60 and the fourth metal terminal 70 attached to the second flange 31 also have the same effect as (1) in joining of the wires.

(8) In the above embodiment, the areas of the upper surfaces of the flat surface parts are equal to each other. Therefore, for each metal terminal, thermocompression bonding can be performed without changing setting of the load when an end of each wire is thermocompression-bonded to each flat surface part. As a result, it is possible to suppress complication of process at the time of manufacturing the coil component 10.

(9) In the above embodiment, the dimension in the direction along the up-down axis Y from the position located on the uppermost side in the upward direction Y1 to the position located on the lowermost side in the downward direction Y2 of the first inclined portion 45B is larger than the outer diameter of the first wire 81. According to this configuration, the outer diameter of the first wire 81 is maintained on the downward direction Y2 side of the first inclined portion 45B. Therefore, it is possible to more reliably suppress the disconnection of the first wire 81 at a boundary between the first joining part 45 and an outside of the first joining part 45. In this respect, the same effect is obtained also in each metal terminal.

### Modifications

The above embodiment and the following modifications can be implemented in combination with each other within a range not technically contradictory.

In the above embodiment, configuration of the coil component 10 is not limited. For example, the plate core 10F can be omitted from the coil component 10. Further, the shapes of the first flange 21 and the second flange 31 are not limited to the shapes in the above embodiment. For example, the projecting portion 23 can be omitted from the first flange 21.

In the above embodiment, the shape of the winding core 11 is not limited to an example in the above embodiment. For example, the shape of the winding core 11 may be an elliptical columnar shape, or a polygonal columnar shape other than the quadrangular prism shape.

In the above embodiment, the shape of each wire is not limited to an example in the above embodiment. When viewed in a section orthogonal to a direction in which each wire extends, the shape of the wire may be an elliptical shape other than a circle or a polygonal shape.

In the above embodiment, the outer diameter of each wire is not particularly limited.

In the above embodiment, the materials of the drum core 10C and the plate core 10F are not limited to examples in the above embodiment. For example, the materials of the drum core 10C and the plate core 10F are not limited to Ni-Zn-based ferrite, and may be Mn-Zn-based ferrite. Further, the materials of the drum core 10C and the plate core 10F may be ferrite, alumina, a synthetic resin, a mixture thereof, or the like.

In the above embodiment, the shape of the plate core 10F is not limited to the rectangular plate shape. For example, the plate core 10F may have an elliptical plate shape or the like.

In the above embodiment, the shape of the first metal terminal 40 is not limited to an example in the above embodiment. The first metal terminal 40 has the first joining part 45 facing the upper surface of the first flange 21. In this respect, the same applies to each metal terminal. Specifically, for example, the first metal terminal 40 may not have the first bonding portion and the first coupling portion. In this case, the first metal terminal 40 is fixed to the first flange 21 by the first joining part 45, the first mounting part 43, the first extending portion 44, or any plurality thereof.

In the above embodiment, in the first metal terminal 40, the first mounting part 43 and the first joining part 45 may be at the same height on the up-down axis Y. Furthermore, in this case, the first mounting part 43, the first extending portion 44, and the first joining part 45 may be flush with each other.

In the above embodiment, the first joining part 45 may be separated from the upper surface of the first flange 21. Further, the first joining part 45 may be fixed to the first flange 21 with the adhesive or the like. In this respect, the same applies to the second joining part 55 to the fourth joining part 75.

In the above embodiment, a clear ridgeline may not be formed between the first flat surface part 45A and the first inclined portion 45B. That is, the upper surface of the first joining part 45 may have a curved portion. Further, the upper surface of the first inclined portion 45B is not limited to a flat surface, and may be a curved surface. In this respect, the same applies to the second joining part 55 to the fourth joining part 75.

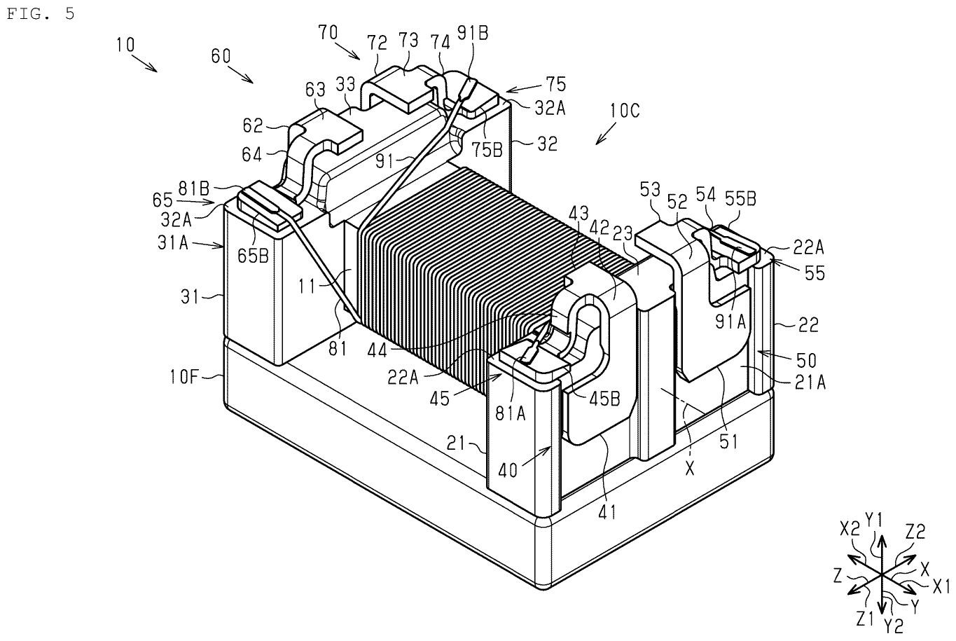

In the above embodiment, the first joining part 45 may not have the first flat surface part 45A. For example, in an example shown in FIG. 5, an entire first joining part 45 is the first inclined portion 45B. In this case, the first end 81A of the first wire 81 is joined to the upper surface of the first inclined portion 45B. Further, in the example shown in FIG. 5, an entire second joining part 55 is the second inclined portion 55B. An entire third joining part 65 is the third inclined portion 65B. An entire fourth joining part 75 is the fourth inclined portion 75B.

In the above embodiment, the first end 81A of the first wire 81 may not be joined to both the upper surface of the first flat surface part 45A and the upper surface of the first inclined portion 45B. That is, the first end 81A of the first wire 81 may be joined only to the upper surface of the first flat surface part 45A or the upper surface of the first inclined portion 45B. In this respect, the same applies to the second joining part 55 to the fourth joining part 75.

In the above embodiment, in the first inclined portion 45B, as long as the upper surface is inclined in the downward direction Y2 toward the winding core 11 in the direction along the left-right axis Z, inclination and curvature of the first inclined portion 45B may be changed on the way. In this regard, the same applies to the second inclined portion 55B to the fourth inclined portion 75B, and the inclination and the curvature may be changed in the middle of the inclined portion.

In the above embodiment, when viewed toward the downward direction Y2, the first wire 81 may not overlap the first inclined end 45C. That is, when viewed toward the downward direction Y2, the first wire 81 may pass through the end of the first inclined portion 45B on the second flange 31 side in the direction along the central axis X. Also in this case, in a portion of the first wire 81 overlapping the first inclined portion 45B, the first end 81A of the first wire 81 can be prevented from being excessively crushed. In this regard, the same applies to other inclined ends, and each wire may not overlap each inclined end when viewed toward the downward direction Y2.

In the above embodiment, as long as the first joining part 45 has the first inclined portion 45B, the second joining part 55 may not have the second inclined portion 55B. The third joining part 65 may not have the third inclined portion 65B. Further, the fourth joining part 75 may not have the fourth inclined portion 75B.

In the above embodiment, the shortest distance from the upper surface of the first flange 21 to the first flat surface part 45A in the direction along the up-down axis Y may not be equal to the shortest distance from the upper surface of the first flange 21 to the second flat surface part 55A in the direction along the up-down axis Y. Note that, the shortest distances from the upper surfaces of the flanges to the flat surface parts may be different from each other.

In the above embodiment, the thickness dimension T1 from the lower surface to the upper surface of the first flat surface part 45A in the direction along the up-down axis Y may not be equal to the thickness dimension T2 from the lower surface to the upper surface of the second flat surface part 55A in the direction along the up-down axis Y. Note that the thickness dimensions of the flat surface parts may be different from each other.

In the above embodiment, the areas of the flat surface parts of the metal terminals may be different from each other.

In the above embodiment, on the upper surface of the first inclined portion 45B, the dimension in the direction along the up-down axis Y from the position located on the uppermost side in the upward direction Y1 to the position located on the lowermost side in the downward direction Y2 may be smaller than the outer diameter of the first wire 81. In this respect, the same applies to other inclined portions.

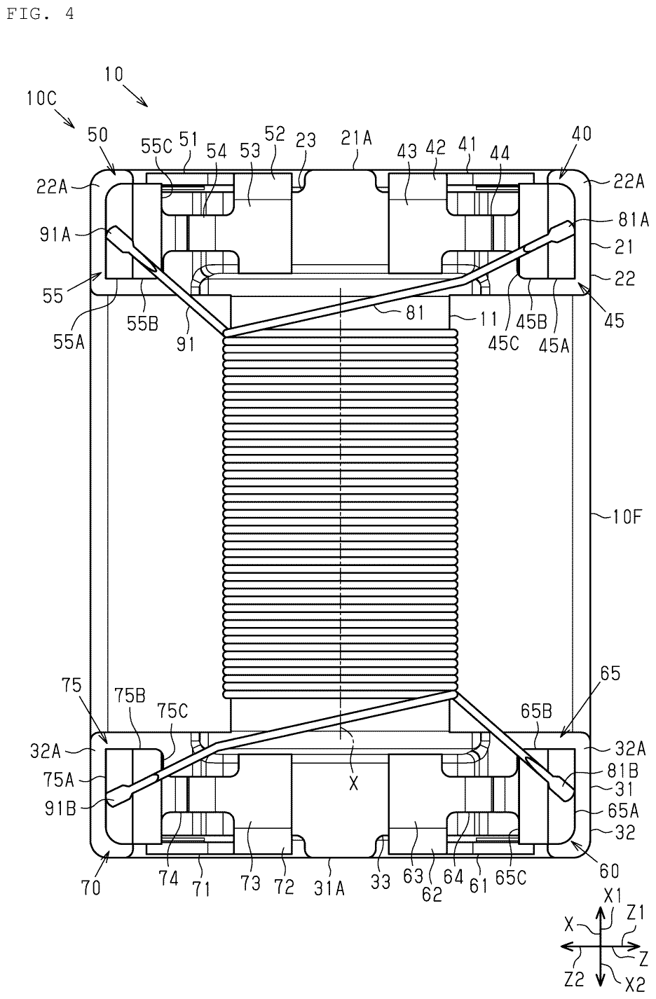

In the above embodiment, the second inclined portion 55B of the second metal terminal 50 may be adjacent to the second flat surface part 55A in the direction along the left-right axis Z. In an example shown in FIG. 4, the second metal terminal 50 has the second joining part 55 facing the upper surface of the first flange 21. The second joining part 55 includes the second flat surface part 55A and the second inclined portion 55B. The second inclined portion 55B is adjacent to the second flat surface part 55A on the winding core 11 side in the direction along the left-right axis Z. The upper surface of the second inclined portion 55B is inclined in the downward direction Y2 toward the winding core 11 in the direction along the left-right axis Z. In the example shown in FIG. 4, the first end 91A of the second wire 91 is joined to the upper surface of the second flat surface part 55A of the second joining part 55, and the second wire 91 overlaps the second inclined portion 55B when viewed toward the downward direction Y2.

In the example shown in FIG. 4, the third metal terminal 60 has the third joining part 65 facing the upper surface of the second flange 31. The third joining part 65 includes the third flat surface part 65A and the third inclined portion 65B. The third inclined portion 65B is located on the winding core 11 side with respect to the third flat surface part 65A in the direction along the left-right axis Z. The upper surface of the third inclined portion 65B is inclined in the downward direction Y2 toward the winding core 11 in the direction along the left-right axis Z. In the example shown in FIG. 4, the second end 81B of the first wire 81 is joined to the upper surface of the third flat surface part 65A of the third joining part 65, and the first wire 81 overlaps the third inclined portion 65B when viewed toward the downward direction Y2.

In the example shown in FIG. 4, the second inclined portion 55B is positioned according to a direction of the second wire 91 extended from the winding core 11 toward the second metal terminal 50. That is, also in the example shown in FIG. 4, the effect described in (1) of the above embodiment can be obtained in each metal terminal including the second metal terminal 50.

### Supplementary Note

A technical idea that can be grasped from the above embodiment and modifications will be described.

[1] A coil component includes a drum core including a columnar winding core, a first flange provided at a first end in a direction along a central axis of the winding core, and a second flange provided at a second end opposite to the first end of the winding core; a first metal terminal provided on the first flange; and a first wire wound around the winding core and having a first end and a second end opposite to the first end. The first flange protrudes outward with respect to the winding core in a direction along an up-down axis orthogonal to the central axis when viewed from a direction along the central axis. Also, when an axis orthogonal to both the up-down axis and the central axis is defined as a left-right axis, one of directions along the up-down axis is defined as an upward direction, and a direction opposite to the upward direction is defined as a downward direction, the first metal terminal includes a first joining part, and a lower surface of the first joining part faces an upper surface of the first flange, the first joining part includes a first inclined portion, and an upper surface of the first inclined portion is inclined in the downward direction toward the winding core in a direction along the left-right axis, and a first end of the first wire is joined to an upper surface of the first joining part, and the first wire overlaps the first inclined portion when viewed toward the downward direction.

[2] The coil component according to [1], in which the first joining part further includes a first flat surface part, and an upper surface of the first flat surface part is orthogonal to the up-down axis, and the first inclined portion is adjacent to the first flat surface part on a side of the winding core in the direction along the left-right axis.

[3] The coil component according to [2], in which the first end of the first wire is joined only to the first flat surface part.

[4] The coil component according to [2], in which the first end of the first wire is joined only to the first inclined portion.

[5] The coil component according to [2], in which the first end of the first wire is joined to the first inclined portion and the first flat surface part.

[6] The coil component according to any one of [2] to [5], further including: a second metal terminal provided at a portion of the first flange on a side opposite to the first metal terminal across the central axis in the direction along the left-right axis; and a second wire wound around the winding core and having a first end and a second end opposite to the first end. The second metal terminal includes a second joining part facing the upper surface of the first flange. The second joining part includes a second flat surface part and a second inclined portion adjacent to the second flat surface part on a side of the second flange in the direction along the central axis. An upper surface of the second flat surface part is orthogonal to the up-down axis, an upper surface of the second inclined portion is inclined in the downward direction toward the second flange in the direction along the central axis. Also, a first end of the second wire is joined to an upper surface of the second joining part, and the second wire overlaps the second inclined portion when viewed toward the downward direction.

[7] The coil component according to any one of [2] to [5], further including a second metal terminal provided at a portion of the first flange on a side opposite to the first metal terminal across the central axis in the direction along the left-right axis; and a second wire wound around the winding core and having a first end and a second end opposite to the first end. The second metal terminal includes a second joining part facing the upper surface of the first flange. The second joining part includes a second flat surface part and a second inclined portion adjacent to the second flat surface part on the side of the winding core in the direction along the left-right axis. An upper surface of the second flat surface part is orthogonal to the up-down axis, an upper surface of the second inclined portion is inclined in the downward direction toward the winding core in the direction along the left-right axis. Also, a first end of the second wire is joined to an upper surface of the second joining part, and the second wire overlaps the second inclined portion when viewed toward the downward direction.

[8] The coil component according to [6] or [7], in which an area of the upper surface of the first flat surface part is equal to an area of the upper surface of the second flat surface part.

[9] The coil component according to any one of [6] to [8], in which a shortest distance from the upper surface of the first flange to the first flat surface part in the direction along the up-down axis is equal to a shortest distance from the upper surface of the first flange to the second flat surface part in the direction along the up-down axis.

[10] The coil component according to [9], in which a thickness dimension from a lower surface to an upper surface of the first flat surface part in the direction along the up-down axis is equal to a thickness dimension from a lower surface to an upper surface of the second flat surface part in the direction along the up-down axis.

[11] The coil component according to any one of [6] to [10], further comprising a third metal terminal provided on the second flange and facing the first metal terminal in the direction along the central axis; and a fourth metal terminal provided on the second flange and facing the second metal terminal in the direction along the central axis. The second flange protrudes outward with respect to the winding core in the direction along the up-down axis when viewed from the direction along the central axis. The third metal terminal includes a third joining part facing an upper surface of the second flange. The third joining part includes a third flat surface part and a third inclined portion adjacent to the third flat surface part on the side of the winding core in the direction along the left-right axis. An upper surface of the third flat surface part is orthogonal to the up-down axis, and an upper surface of the third inclined portion is inclined in the downward direction toward the first flange in the direction along the central axis. Also, the fourth metal terminal includes a fourth joining part facing the upper surface of the second flange. The fourth joining part includes a fourth flat surface part and a fourth inclined portion adjacent to the fourth flat surface part on a side of the first flange in the direction along the central axis, an upper surface of the fourth flat surface part is orthogonal to the up-down axis, and an upper surface of the fourth inclined portion is inclined in the downward direction toward the winding core in the direction along the left-right axis. A second end of the first wire is joined to an upper surface of the third joining part, and the first wire overlaps the third inclined portion when viewed toward the downward direction. A second end of the second wire is joined to an upper surface of the fourth joining part, and the second wire overlaps the fourth inclined portion when viewed toward the downward direction.

[12] The coil component according to [11], in which an area of the upper surface of the first flat surface part, an area of the upper surface of the second flat surface part, an area of the upper surface of the third flat surface part, and an area of the upper surface of the fourth flat surface part are equal to each other.

[13] The coil component according to or [12], in which a thickness dimension from a lower surface to an upper surface of the first flat surface part in the direction along the up-down axis, a thickness dimension from a lower surface to an upper surface of the second flat surface part in the direction along the up-down axis, a thickness dimension from a lower surface to an upper surface of the third flat surface part in the direction along the up-down axis, and a thickness dimension from a lower surface to an upper surface of the fourth flat surface part in the direction along the up-down axis, are equal to each other.

[14] The coil component according to any one of [1] to [13], in which the first inclined portion reaches a first inclined end which is an end of the first joining part on a side of the winding core in the direction along the left-right axis, and the first wire overlaps the first inclined end when viewed toward the downward direction.

[15] The coil component according to any one of [1] to [14], in which a dimension in a direction along the up-down axis from a position located on an uppermost side in the upward direction to a position located on a lowermost side in the downward direction on the upper surface of the first inclined portion is larger than an outer diameter of the first wire.

What is claimed is:

1. A coil component comprising:
a drum core including a columnar winding core, a first flange at a first end in a direction along a central axis of the winding core, and a second flange at a second end opposite to the first end of the winding core;
a first metal terminal on the first flange; and
a first wire wound around the winding core and having a first end and a second end opposite to the first end,
wherein
the first flange protrudes outward with respect to the winding core in a direction along an up-down axis orthogonal to the central axis when viewed from a direction along the central axis,
when an axis orthogonal to both the up-down axis and the central axis is defined as a left-right axis, one of directions along the up-down axis is defined as an upward direction, and a direction opposite to the upward direction is defined as a downward direction,
the first metal terminal includes a first joining part, and a lower surface of the first joining part faces an upper surface of the first flange,
the first joining part includes a first inclined portion, and an upper surface of the first inclined portion is inclined in the downward direction toward the winding core in a direction along the left-right axis, and
a first end of the first wire is joined to an upper surface of the first joining part, and the first wire overlaps the first inclined portion when viewed toward the downward direction.

2. The coil component according to claim 1, wherein
the first joining part further includes a first flat surface part, and an upper surface of the first flat surface part is orthogonal to the up-down axis, and
the first inclined portion is adjacent to the first flat surface part on a side of the winding core in the direction along the left-right axis.

3. The coil component according to claim 2, wherein
the first end of the first wire is joined only to the first flat surface part.

4. The coil component according to claim 2, wherein
the first end of the first wire is joined only to the first inclined portion.

5. The coil component according to claim 2, wherein
the first end of the first wire is joined to the first inclined portion and the first flat surface part.

6. The coil component according to claim 2, further comprising:
a second metal terminal at a portion of the first flange on a side opposite to the first metal terminal across the central axis in the direction along the left-right axis; and
a second wire wound around the winding core and having a first end and a second end opposite to the first end,
wherein
the second metal terminal includes a second joining part facing the upper surface of the first flange,
the second joining part includes a second flat surface part and a second inclined portion adjacent to the second flat surface part on a side of the second flange in the direction along the central axis,
an upper surface of the second flat surface part is orthogonal to the up-down axis,
an upper surface of the second inclined portion is inclined in the downward direction toward the second flange in the direction along the central axis, and
a first end of the second wire is joined to an upper surface of the second joining part, and the second wire overlaps the second inclined portion when viewed toward the downward direction.

7. The coil component according to claim 2, further comprising:
a second metal terminal at a portion of the first flange on a side opposite to the first metal terminal across the central axis in the direction along the left-right axis; and
a second wire wound around the winding core and having a first end and a second end opposite to the first end,
wherein
the second metal terminal includes a second joining part facing the upper surface of the first flange,
the second joining part includes a second flat surface part and a second inclined portion adjacent to the second flat surface part on the side of the winding core in the direction along the left-right axis,
an upper surface of the second flat surface part is orthogonal to the up-down axis,
an upper surface of the second inclined portion is inclined in the downward direction toward the winding core in the direction along the left-right axis, and
a first end of the second wire is joined to an upper surface of the second joining part, and the second wire overlaps the second inclined portion when viewed toward the downward direction.

8. The coil component according to claim 6, wherein
an area of the upper surface of the first flat surface part is equal to an area of the upper surface of the second flat surface part.

9. The coil component according to claim 6, wherein
a shortest distance from the upper surface of the first flange to the first flat surface part in the direction along the up-down axis is equal to a shortest distance from the upper surface of the first flange to the second flat surface part in the direction along the up-down axis.

10. The coil component according to claim 9, wherein
a thickness dimension from a lower surface to an upper surface of the first flat surface part in the direction along the up-down axis is equal to a thickness dimension from a lower surface to an upper surface of the second flat surface part in the direction along the up-down axis.

11. The coil component according to claim 6, further comprising:
a third metal terminal on the second flange and facing the first metal terminal in the direction along the central axis; and
a fourth metal terminal on the second flange and facing the second metal terminal in the direction along the central axis,
wherein
the second flange protrudes outward with respect to the winding core in the direction along the up-down axis when viewed from the direction along the central axis,
the third metal terminal includes a third joining part facing an upper surface of the second flange,
the third joining part includes a third flat surface part and a third inclined portion adjacent to the third flat surface part on the side of the winding core in the direction along the left-right axis,
an upper surface of the third flat surface part is orthogonal to the up-down axis,
an upper surface of the third inclined portion is inclined in the downward direction toward the first flange in the direction along the central axis,
the fourth metal terminal includes a fourth joining part facing the upper surface of the second flange,
the fourth joining part includes a fourth flat surface part and a fourth inclined portion adjacent to the fourth flat surface part on a side of the first flange in the direction along the central axis,
an upper surface of the fourth flat surface part is orthogonal to the up-down axis,
an upper surface of the fourth inclined portion is inclined in the downward direction toward the winding core in the direction along the left-right axis,
a second end of the first wire is joined to an upper surface of the third joining part, and the first wire overlaps the third inclined portion when viewed toward the downward direction, and
a second end of the second wire is joined to an upper surface of the fourth joining part, and the second wire overlaps the fourth inclined portion when viewed toward the downward direction.

12. The coil component according to claim 11, wherein
an area of the upper surface of the first flat surface part, an area of the upper surface of the second flat surface part, an area of the upper surface of the third flat surface part, and an area of the upper surface of the fourth flat surface part, are equal to each other.

13. The coil component according to claim 11, wherein
a thickness dimension from a lower surface to an upper surface of the first flat surface part in the direction along the up-down axis,
a thickness dimension from a lower surface to an upper surface of the second flat surface part in the direction along the up-down axis,
a thickness dimension from a lower surface to an upper surface of the third flat surface part in the direction along the up-down axis, and
a thickness dimension from a lower surface to an upper surface of the fourth flat surface part in the direction along the up-down axis,
are equal to each other.

14. The coil component according to claim 1, wherein
the first inclined portion reaches a first inclined end which is an end of the first joining part on a side of the winding core in the direction along the left-right axis, and
the first wire overlaps the first inclined end when viewed toward the downward direction.

15. The coil component according to claim 1, wherein
a dimension in a direction along the up-down axis from a position on an uppermost side in the upward direction to a position on a lowermost side in the downward direction on the upper surface of the first inclined portion is larger than an outer diameter of the first wire.

16. The coil component according to claim 7, wherein
an area of the upper surface of the first flat surface part is equal to an area of the upper surface of the second flat surface part.

17. The coil component according to claim 7, wherein
a shortest distance from the upper surface of the first flange to the first flat surface part in the direction along the up-down axis is equal to a shortest distance from the upper surface of the first flange to the second flat surface part in the direction along the up-down axis.

18. The coil component according to claim 17, wherein
a thickness dimension from a lower surface to an upper surface of the first flat surface part in the direction along the up-down axis is equal to a thickness dimension from a lower surface to an upper surface of the second flat surface part in the direction along the up-down axis.

19. The coil component according to claim 6, further comprising:
a third metal terminal on the second flange and facing the first metal terminal in the direction along the central axis; and
a fourth metal terminal on the second flange and facing the second metal terminal in the direction along the central axis,
wherein
the second flange protrudes outward with respect to the winding core in the direction along the up-down axis when viewed from the direction along the central axis, the third metal terminal includes a third joining part facing an upper surface of the second flange,
the third joining part includes a third flat surface part and a third inclined portion adjacent to the third flat surface part on the side of the winding core in the direction along the left-right axis,
an upper surface of the third flat surface part is orthogonal to the up-down axis,
an upper surface of the third inclined portion is inclined in the downward direction toward the first flange in the direction along the central axis,
the fourth metal terminal includes a fourth joining part facing the upper surface of the second flange,
the fourth joining part includes a fourth flat surface part and a fourth inclined portion adjacent to the fourth flat surface part on a side of the first flange in the direction along the central axis,
an upper surface of the fourth flat surface part is orthogonal to the up-down axis, an upper surface of the fourth inclined portion is inclined in the downward direction toward the winding core in the direction along the left-right axis,
a second end of the first wire is joined to an upper surface of the third joining part, and the first wire overlaps the third inclined portion when viewed toward the downward direction, and
a second end of the second wire is joined to an upper surface of the fourth joining part, and the second wire overlaps the fourth inclined portion when viewed toward the downward direction.

20. The coil component according to claim 19, wherein
an area of the upper surface of the first flat surface part, an area of the upper surface of the second flat surface part, an area of the upper surface of the third flat surface part, and an area of the upper surface of the fourth flat surface part, are equal to each other.
